(19) United States
(12) Patent Application Publication
(10) Pub. No.: US 2016/0154132 A1
(43) Pub. Date: Jun. 2, 2016

(54) METHOD OF ACOUSTIC WELL LOGGING

(71) Applicant: SCHLUMBERGER TECHNOLOGY CORPORATION, Sugar Land, TX (US)

(72) Inventor: Dmitry Belov, St.Petersburg (RU)

(21) Appl. No.: 14/953,234

(22) Filed: Nov. 27, 2015

(30) Foreign Application Priority Data
Nov. 27, 2014 (RU) 2014147816

(51) Int. Cl. G01V 1/44

(52) U.S. Cl. CPC G01V 1/44

(57) ABSTRACT

A logging tool is disposed in a borehole; the logging tool is capable of being moved and has at least one section comprising at least one transmitter of directional acoustic signals and at least one section comprising at least one acoustic signal receiver comprising an array of sensors installed circumferentially in fixed positions relative to each other. A relative angle of rotation of the acoustic logging tool around its axis is determined at each step of acoustic logging. A correction angle is computed for the sections comprising at least one transmitter of the directional acoustic signals, and/or for the sections comprising at least one acoustic signal receiver. The correctional rotation of the sections for which the correction angle has been computed is carried out.

### CROSS-REFERENCE TO RELATED APPLICATION

This application claims priority to Russian Application No. 2014147816 filed Nov. 27, 2014, which is incorporated herein by reference in its entirety.

### BACKGROUND

The invention relates to geophysical surveys, in particular, to acoustic well logging.

Acoustic well logging is one of the methods used in field practice for acoustic well-logging measurements. In an acoustic well logging operation, a transmitter is used to emit elastic oscillations which propagate in the wellbore fluids and surrounding rocks and are detected by acoustic receivers placed in the same wellbore. Generally, acoustic well logging is performed using downhole logging tools to determine travel times of the key types of waves as the acoustic energy travels in the formation rock from the transmitter to the receiver array. Data acquired during such surveys allow geoscientists to create geo-acoustic models of well sections for seismic data interpretation, determine rock elasticity moduli, evaluate rock porosity, etc. Quality of acoustic data provided by acoustic well logging tools depends on many factors, such as wellbore shape, signal source type, position of logging tools, etc. The last factor is especially critical for logging tools with directional sources, i.e. sources with pre-determined signal propagation direction according to a polar pattern. In this case, the polar pattern of an acoustic signal source pressure field (as applied to sources emitting in liquid media, i.e. in media present in the wellbore) means the dependence of pressure amplitude provided by the source from angular coordinates and observation point in horizontal and/or vertical planes. Such sources, for example, include dipole or quadrupole acoustic sources used in logging tools designed to determine rock anisotropy along the wellbore.

One of the problems of acoustic well logging with directional sources is the rotation of a tool from measurement to measurement mostly due to influence of the cable which is used to run the logging tools in the borehole, as well as by many other reasons. To eliminate rotation effects, special sensors are installed to measure angle of rotation of the logging tool around its axis at each logging step. The rotation sensor data are used during processing of acoustic data (acoustic traces) recorded by the receivers (see, for example, Darwin V. Ellis, and Julian M. Singer, Well Logging for Earth Scientists, Springer: Dordrecht, The Netherlands (2008) p. 524, 549-550, J. Walsh, J. Urdea, J. Hyde, H. Simon (Schlumberger), S. Horen, WesternGeco, C. Thompson (4C Exploration), G. De, R. Morgan (Chevron Texaco) Determining Fracture or Stress Direction Through Casing: A Case Study//43rd Annual SPWLA Symposium, Jun. 2-5, 2002, or RF patent 2326237).

At the same time, there are restrictions on maximum rotation angle of the tool around its axis during two sequential acoustic measurements. The quality of logging data significantly decreases in case of exceeding of maximal admissible rotation's angle. In this case, data cannot be processed with acceptable accuracy.

### SUMMARY

The proposed method provides for an increased quality of acoustic data acquired during acoustic well logging through compensation of acoustic logging tool rotation during downhole measurements.

According to the proposed method, a logging tool is disposed in a borehole; the logging tool is capable of being moved and has at least one section comprising at least one transmitter of directional acoustic signals and at least one section comprising at least one acoustic signal receiver consisting of an array of sensors installed circumferentially in fixed positions relative to each other. A relative angle of rotation of the acoustic logging tool around its axis is determined at each step of acoustic logging. A correction angle is computed for the sections comprising at least one transmitter of the directional acoustic signals, and/or for the sections comprising at least one acoustic signal receiver, then a correctional rotation of the sections for which the correction angle has been computed is carried out, the correctional rotation is carried out by the computed correction angle.

The relative angle of rotation of the acoustic logging tool can be determined based on data from the sensors which can measure, for example, direction of gravity or direction of the Earth magnetic field.

The logging tool can use dipole or quadrupole directional signal sources.

The rotation of the sections of the acoustic logging tool by the computed correction angle can be carried out by any drive mechanism (such as mechanical or magnetic drive mechanisms, etc.).

### BRIEF DESCRIPTION OF DRAWINGS

The invention is explained by the drawings.

FIG. 1A-FIG. 1D show an example of correction algorithm for irregular rotation of a tool, which contains a receiver and a dipole acoustic source;

FIG. 2A-FIG. 2D show an example of correction algorithm for irregular rotation of a tool, which contains a receiver and a quadrupole acoustic source.

### DETAILED DESCRIPTION

An acoustic signal is emitted by a transmitter (or multiple transmitters), which is part of an acoustic logging tool. The acoustic signal travels through a wellbore fluid and surrounding elastic materials; the acoustic field created in the wellbore by the transmitter is recorded (registered) by acoustic receivers. It is assumed that the transmitter emits directional signals (for example, by dipole or quadrupole acoustic signal sources). Each acoustic receiver consists of an array of circumferentially installed sensors whose positions relative to each other are fixed. In this case, each receiving sensor records a unique set of acoustic data (accordingly with the number of circumferentially installed sensors) due to differences in travel times. The tool can contain any combination of alternating transmitter and receiver sections; for instance, the tool can have a transmitter section followed by a receiver section, then a receiver section followed by a transmitter section (similar to some tools), or may have any other configurations.

At each step of acoustic logging operation the acoustic logging tool can rotate around its axis by a certain angle due to borehole irregularities, effects of wireline tension, wellbore geometry, etc. Accordingly, as the tool rotates around its axis, a polar pattern of the directional acoustic signal source also changes from one measurement to another, relative to an initial survey point. The receiver inside the logging tool can rotate in a similar way, resulting in changed spatial orientation of the sensors installed circumferentially around the tool axis, relative to the previous step of acoustic survey. Correction rotation of the transmitter sections and the receiver sections around the tool axis by a specific angle at each step of acoustic logging allows to keep constant the polar patterns of the directional acoustic signal source(s) relative to the initial survey point and constant spatial orientation of the receiver sensors. The correction rotation allows logging data to be acquired without any further corrections for tool rotation after each logging step during data processing.

A relative angle of rotation of the acoustic logging tool can be determined at each step of acoustic logging by special sensors or any other methods. A special sensor (or sensors) can be used for measuring direction of gravity (which is especially important in horizontal and directional wells), direction of Earth magnetic field, or can be used for orientation against the markers pre-installed on the casing, or measure other parameters for quantitative determination of tool rotation inside the wellbore and, therefore, the required adjustment angle.

Sensors which provide information about direction of gravity vector can be used for determining the direction of gravity. This group of sensors comprises different types of physical pendulums. The second group of gravity sensors includes sensors which register acceleration, in particular, acceleration of gravity (accelerometers). Examples of such sensors include a family of micromechanical integrated accelerometers iMEMS (http://www.analog.com/en/mems-sensors/mems-accelerometers/products/index.html#MEMS_Accelerometers) manufactured by Analog Devices, in particular, ADXL206 (http://www.analog.com/en/mems-sensors/mems-accelerometers/adx1206/products/product.html) and tilt sensor DUN-02 (http://www.grant-ufa.ru/pdf/dun-02.pdf) manufactured by Grant (http://www.grant-ufa.ru/). This sensor provides tilt angle measurements in two horizontal axes relative to the direction of gravity, as well as angle of rotation measurements (if the sensor rotation axis is normal to the Earth gravity direction).

Various magnetic field sensors can be used for determining the direction Earth magnetic fields, including devices that emit electric signals whose properties depend on magnetic field density (normally, one of field projections in a given direction). There are many types of sensors which can be used for measuring magnetic fields. Primary types of sensors are magnetomechanical, induction, galvanomagnetic, magnetic resonance, ferroprobe, magnetoresistive, as well as SQUID (Superconducting Quantum Interference Devices). Examples of such sensors can be found in patents U.S. Pat. No. 6,692,847, Japan patent application No. 10/020946, USSR patent No. 1190743, RF patent No. 2202805.

Optical and ultrasonic sensors can be used for tool orientation relative to pre-installed markers. Ultrasonic sensors are especially efficient in limited visibility or if the tool is oriented by notches on the surface of casing string. Examples of such sensors can be found here: http://www.sensorlink.ru/pdf/Datalogic-2011_rus.pdf. Other types of sensors can be used as well, such as radiation sensors (if radioactive markers are used), magnetic field sensors (for magnetic markers), etc.

Measured parameters are transmitted to a data processing module (a computer system) which can be housed inside the logging tool or installed on surface (in the latter case, data can be transmitted by any suitable system). The processing module computes the required correction angle (the angle of rotation) for the transmitter sections and/or the receiver sections. Besides, the angle of rotation at each step of the logging operation can be determined by directly measuring the angle of rotation of the tool in the wellbore using any suitable method. The reverse mechanical rotation of the transmitter and the receiver sections of the logging tool by the required angle can be provided by any drive mechanism (such as mechanical or magnetic drive mechanism, etc.) by any method.

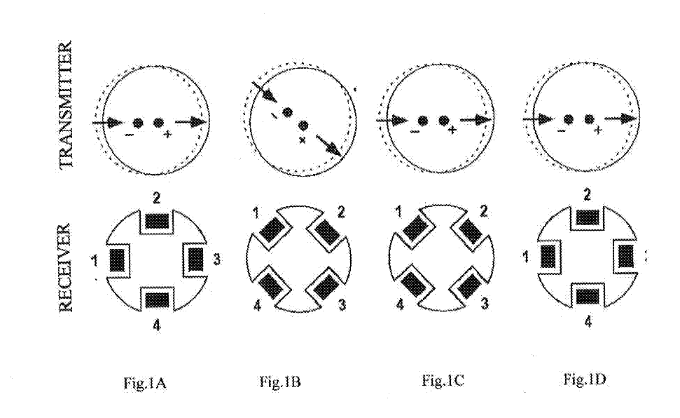

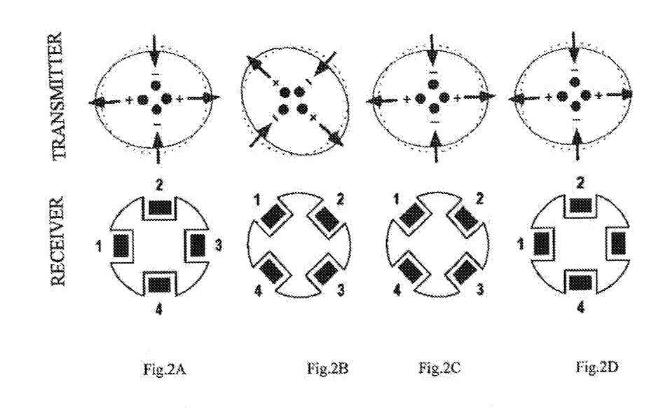

Algorithm of the correction is shown on FIG. 1A-FIG. 1D, which provides an example of a system consisting of one section with one dipole transmitter and one section with one combined receiver, and on FIG. 2A-FIG. 2D, which provides an example of a system consisting of one section with one quadrupole transmitter and one section with one combined received.

On FIG. 1A, an initial position of the transmitter and the receiver is shown. Sensors 1 and 3 incorporated in the receiver are co-directional (parallel) to a polar pattern of the dipole transmitter; sensors 2 and 4 are perpendicular to the polar pattern.

FIG. 1B corresponds to tool rotation by some angle Q caused by external effects on the tool (the tool rotates in clockwise direction). The transmitter and the receiver of acoustic signals have the same position relative to each other as before rotation.

FIG. 1C represents correctional (reverse) rotation of the transmitter section by the angle Q (the tool rotates in counter-clockwise direction). Before the rotation, information on the tool rotation (in clockwise direction) was received from special sensor's measurements. In this case, the transmitter section was rotated in the reverse direction by the same angle, while the receiver section was not rotated. As a result, the receiver sensors 1 and 3 are not parallel to the polar pattern of the corrected dipole transmitter (same as the sensors 2 and 4). This can be applied in cases when only transmitter can be rotated and relative position of the receiver sensors is not important (or when a transmitter has a different design).

FIG. 1D represents correctional rotation of the receiver section by the angle Q (the tool rotates in counter-clockwise direction). In this case, the receiver sensors 1 and 3 are co-directional (parallel) to the polar pattern of the dipole transmitter; the sensors 3 and 4 are normal to the polar pattern. Thus, the system has been brought to the initial position shown on FIG. 1A. Such a scenario is possible when both signal section and receiver section are rotated.

In the latter case, i.e. when the transmitter and the receiver sections can be rotated synchronously FIG. 1D), for any measurement the relative position of the circumferential sensors of each receiver (assuming the tool has multiple receivers) and direction of the transmitter signal are known because they are constant for each logging step. This feature allows to simplify acoustic data processing sequence.

On FIG. 2A, an initial position of the transmitter and the receiver is shown. Sensors 1 and 3 incorporated in the receiver are co-directional (parallel) to the “+” direction of a quadrupole transmitter polar pattern, sensors 2 and 4 are d co-directional (parallel) to the “−” direction of the quadrupole transmitter polar pattern and, therefore, normal to the “+” direction.

FIG. 2B represents irregular rotation of the tool by an angle Q (the tool rotates in clockwise direction) caused by external effects on the tool.

FIG. 2C represents correctional (reverse) rotation of the transmitter section by the angle Q (the tool rotates in counter-clockwise direction). In this case, the receiver sensors 1 and 3 and, correspondingly, 2 and 4 are not parallel to respective directions of the corrected transmitter polar pattern.

FIG. 2D represents correctional rotation of the transmitter section by the angle Q (the tool rotates in counter-clockwise direction). The sensors 1 and 3 incorporated in the receiver are parallel to the “+” direction of the quadrupole transmitter polar pattern, the sensors 2 and 4 and parallel to the “−” direction of the quadrupole transmitter polar pattern and, therefore, normal to the “+” direction. Thus, the system has been brought to the initial position (shown on FIG. 1A).

The same correction algorithm is applied if multiple sections are used, the only difference is that all transmitter sections and all receiver sections should be rotated simultaneously.

1. A method for acoustic logging, the method comprising:
disposing a logging tool in a borehole, the logging tool capable of being moved and having at least one first section comprising at least one transmitter of a directional acoustic signals and at least one second section comprising at least one acoustic signal receiver comprising an array of sensors installed circumferentially in fixed positions relative to each other;
determining a relative angle of rotation of the logging tool around its axis at each step of acoustic logging;
computing a correction angle for the at least one first section and/or for the at least one second section, and
carrying out a correctional rotation of the at least one first section and/or second section for which the correction angle has been computed, the correctional rotation is carried out by the computed correction angle.

2. The method of claim 1 wherein the relative angle of rotation of the logging tool around its axis is determined using sensor measurements.

3. The method of claim 2 wherein the array of sensors are measuring a direction of gravity.

4. The method of claim 2 wherein the array of sensors are measuring a direction of the earth magnetic field.

5. The method of claim 1 wherein the transmitter of the directional acoustic signals is a dipole transmitter.

6. The method of claim 1 wherein the transmitter of the directional acoustic signals is a quadrupole transmitter.

7. The method of claim 1 wherein the correctional rotation of the at least one first and/or second section of the acoustic logging tool to the correction angle is carried out by a drive.

8. The method of claim 7 wherein the drive is a mechanical drive.

9. The method of claim 7 wherein the drive is a magnetic drive.
